(19) United States
(12) Patent Application Publication
(10) Pub. No.: US 2012/0091662 A1
(43) Pub. Date: Apr. 19, 2012

(54) LABYRINTH SEAL SYSTEM

(75) Inventors: Sudhakar Neeli, Bangalore (IN); Joshy John, Bangalore (IN)

(73) Assignee: GENERAL ELECTRIC COMPANY, Schenectady, NY (US)

(21) Appl. No.: 12/907,452

(22) Filed: Oct. 19, 2010

(51) Int. Cl. F16J 15/447

(52) U.S. Cl. 277/420

(57) ABSTRACT

A labyrinth seal system is disclosed, including a stationary component having a plurality of radially inwardly projecting, axially spaced teeth extending therefrom; and a rotor having a plurality of radially outwardly projecting, axially spaced protrusions, each protrusion having a low pressure side and a high pressure side, wherein the low pressure side of at least one protrusion extends farther in a radial direction than the high pressure side.

### BACKGROUND OF THE INVENTION

The disclosure relates generally to rotary turbomachines, and more particularly, to a labyrinth seal system for use in a turbomachine.

In rotary machines such as turbines, seals are provided between rotating and stationary components. For example, in steam turbines, it is customary to provide a plurality of arcuate packing ring segments to form an annular labyrinth seal between the stationary and rotating components. Typically, the arcuate packing ring segments (typically, four to six per annular seal) are disposed in an annular groove in the stationary component concentric to the axis of rotation of the machine and hence concentric to the sealing surface of the rotating component. Each arcuate seal segment carries an arcuate seal face in opposition to the sealing surface of the rotating component. In labyrinth type seals, the seal faces carry a radially directed array of axially spaced teeth, in which teeth are radially spaced from an array of axially spaced annular teeth forming the sealing surface of the rotating component. The sealing function is achieved by creating turbulent or flow restriction of an operative fluid, for example, steam, as it passes through the relatively tight clearances within the labyrinth defined by the seal face teeth and the opposing surface of the rotating component.

One variation of a labyrinth seal that has been used to maintain an effective seal is a labyrinth seal system with a series of teeth extending from a stationary component toward the rotating component, and a surface of the rotating component having a land with a series of raised chamfers extending toward the stationary component. However, in this variation of labyrinth seals, alignment of the teeth and the raised chamfers is advisable. If the teeth and the raised chamfers are not lined up, i.e., axially aligned, operating fluid is allowed to flow more easily through the seal, thereby reducing the effectiveness of the seal.

### BRIEF DESCRIPTION OF THE INVENTION

A labyrinth seal system is disclosed, including a stationary component having a plurality of radially inwardly projecting, axially spaced teeth extending therefrom; and a rotor having a plurality of radially outwardly projecting, axially spaced protrusions, each protrusion having a low pressure side and a high pressure side, wherein the low pressure side of at least one protrusion extends farther in a radial direction than the high pressure side.

A first aspect of the disclosure provides a labyrinth seal system comprising: a stationary component having a plurality of radially inwardly projecting, axially spaced teeth extending therefrom; and a rotating component having an outer surface proximate to the plurality of teeth, wherein the outer surface includes a plurality of radially outwardly projecting, axially spaced protrusions, each protrusion having a low pressure side and a high pressure side, wherein the low pressure side of at least one protrusion extends farther in a radial direction than the high pressure side.

A second aspect of the disclosure provides a turbomachine comprising: a plurality of arcuate packing ring segments disposed in an annular groove in a stationary component; each arcuate packing ring segment having a seal face having a plurality of radially inwardly projecting, axially spaced teeth extending therefrom; and a rotating component having an outer surface proximate to the plurality of teeth, wherein the outer surface includes a plurality of radially outwardly projecting, axially spaced protrusions, each protrusion having a low pressure side and a high pressure side, wherein the low pressure side of at least one protrusion extends farther in a radial direction than the high pressure side of the at least one protrusion.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a partial cross-sectional view of an illustrative turbomachine including a seal system;

FIG. 2 is a cross-sectional view of a labyrinth seal system as known in the art;

FIG. 3 is a cross-sectional view of a labyrinth seal system according to an embodiment of the invention;

FIG. 4 is an enlarged view of one protrusion and one tooth of a labyrinth seal system according to embodiments of this invention.

FIGS. 5-14 are enlarged views of alternate geometries of protrusions of a labyrinth seal system according to embodiments of this invention.

FIG. 15 shows a diagram illustrating a flow of operating fluid through a labyrinth seal;

FIG. 16 shows a diagram illustrating a flow of operating fluid through a labyrinth seal system according to an embodiment of this invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

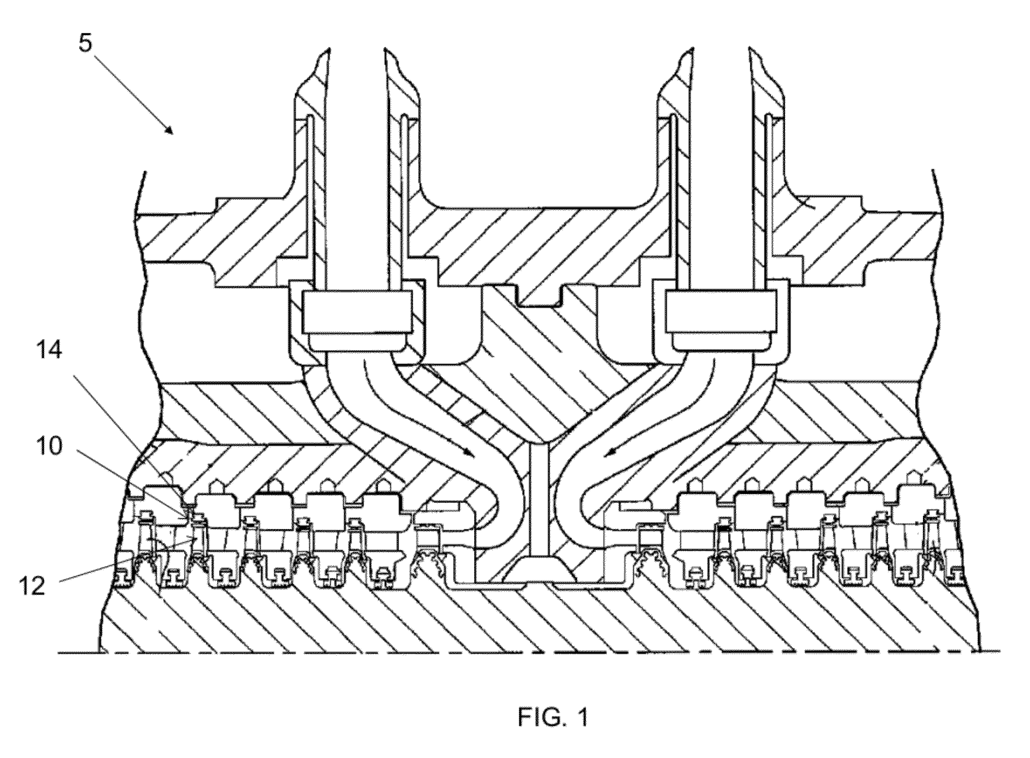

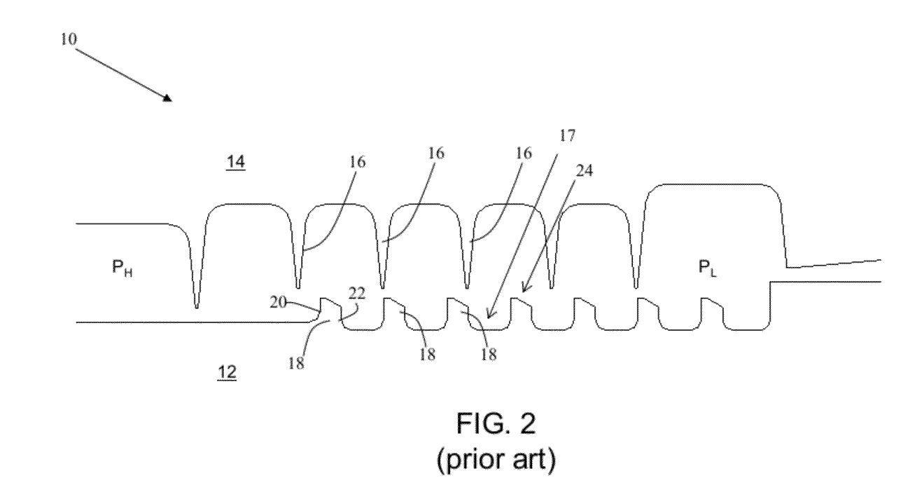

Turning to FIG. 1, a portion of a turbomachine 5 is shown. Turbomachine 5 includes a plurality of labyrinth seal systems 10 to provide a seal between a rotating component 12 and a stationary component 14. One such labyrinth seal system 10, as known in the art, is shown in FIG. 2.

Turning to FIG. 2, a labyrinth seal system 10 as known in the art is shown. Seal system 10 has a high pressure side, P_{H}, and a low pressure side, P_{L}. Operating fluid from a turbomachine 5 (FIG. 1) flows through seal 10 from high pressure side, P_{H}, to low pressure side, P_{L}. As known in the art, seal system 10 includes a stator 14 and a rotor 12. As also known in the art, seal system 10 is a labyrinth seal, i.e., it has a plurality of radially inwardly projecting, axially spaced teeth 16 extending from stationary component 14. In addition, seal system 10 includes a rotor 12 having a rotor land 17, i.e., an outer surface, proximate to teeth 16, including a plurality of radially outwardly projecting, axially spaced protrusions 18. Protrusions 18 have a high pressure side 20 facing high pressure side, P_{H}, of seal system 10, and a low pressure side 22, facing low pressure side, P_{L}, of seal system 10. As shown in FIG. 2, low pressure side 22 of protrusion 18 is radially shorter than high pressure side 20, e.g., low pressure side 22 includes a chamfer 24 that slants away from teeth 16. Seal system 10 is most effective when protrusions 18 and teeth 16 are axially aligned, such that flow through seal 10 is impeded. When protrusions 18 and teeth 16 are not axially aligned, operative fluid will not meet as much resistance, and will flow more unimpeded through seal system 10.

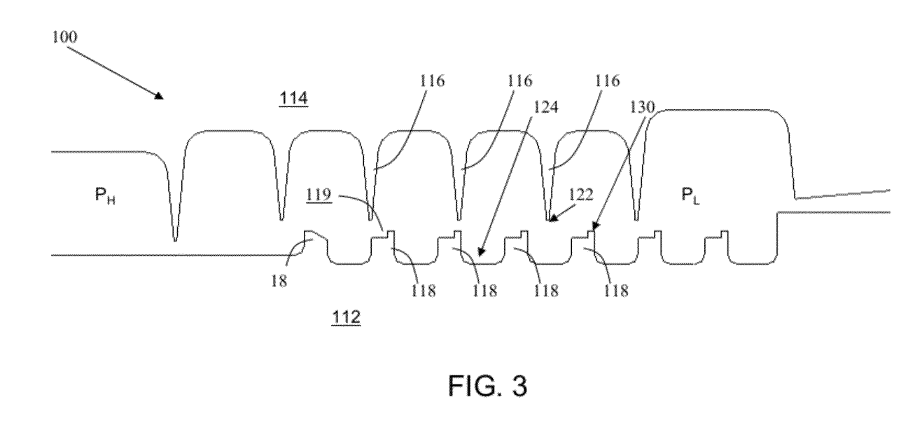

A labyrinth seal system 100 according to embodiments of this invention is shown in FIG. 3. Labyrinth seal system 100 can be used between a stationary component 114 and a rotating component 112 in turbomachine (such as turbomachine 5 partially shown in FIG. 1). Seal system 100 has high pressure side, P_{H}, and a low pressure side, P_{L}. Stationary component 114 has a plurality of radially inwardly projecting, axially spaced teeth 116 extending therefrom. Each tooth 116 has an end portion 122 (also referred to as a tip) that is proximate to rotating component 112. While only one system 100 is shown in FIG. 3, it is understood that as known in the art, labyrinth seal system 100 includes a plurality of arcuate packing ring segments disposed in an annular groove in stationary component 114, with each arcuate packing ring segment having a seal face having a plurality of radially inwardly projecting, axially spaced teeth 116 extending therefrom.

As also shown in FIG. 3, rotating component 112 has an outer surface 124, i.e., rotor land, that is proximate to end portions 122 of teeth 116. Outer surface 124 of rotating component 112 includes a plurality of radially outwardly projecting, axially spaced protrusions 118.

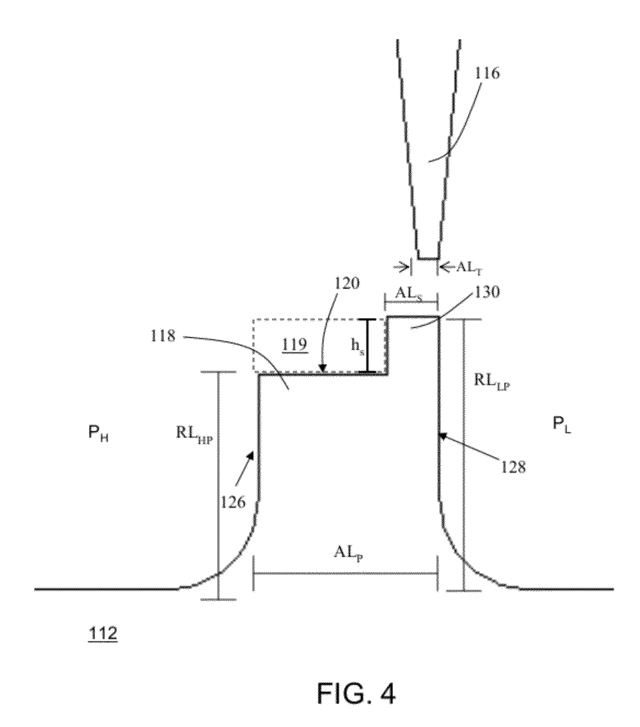

FIG. 4 shows an enlarged view of one protrusion 118 and one tooth 116. As shown in FIG. 4, each protrusion 118 has a low pressure side 128 facing a low pressure side, P_{L}, of seal system 100, and a high pressure side 126 facing a high pressure side, P_{H}, of seal system 100. As shown in FIG. 4, low pressure side 128 extends farther in a radial direction than high pressure side 126. In other words, an axial groove 119 (shown in phantom lines in FIG. 4) has been machined in at least a portion of high pressure side 126, but not all the way through low pressure side 128, such that low pressure side 128 is radially longer than high pressure side 126.

The geometry and shape of protrusion 118 can be altered as desired. For example, as shown in FIGS. 3 and 4, in one embodiment, a substantially rectangular groove 119 has been machined in protrusion 118 such that low pressure side 128 includes a step 130 having a substantially rectangular or substantially square shape. The term “substantially,” as used herein to describe the shape of groove 119 and/or step 130, denotes a general geometric shape, and it is understood that known variations of these shapes are also disclosed. Furthermore, when discussing groove 119 and/or step 130, it is understood that while exact right angles are not necessary, it is desired to have generally sharp angles on protrusion 118 to better impede fluid flow.

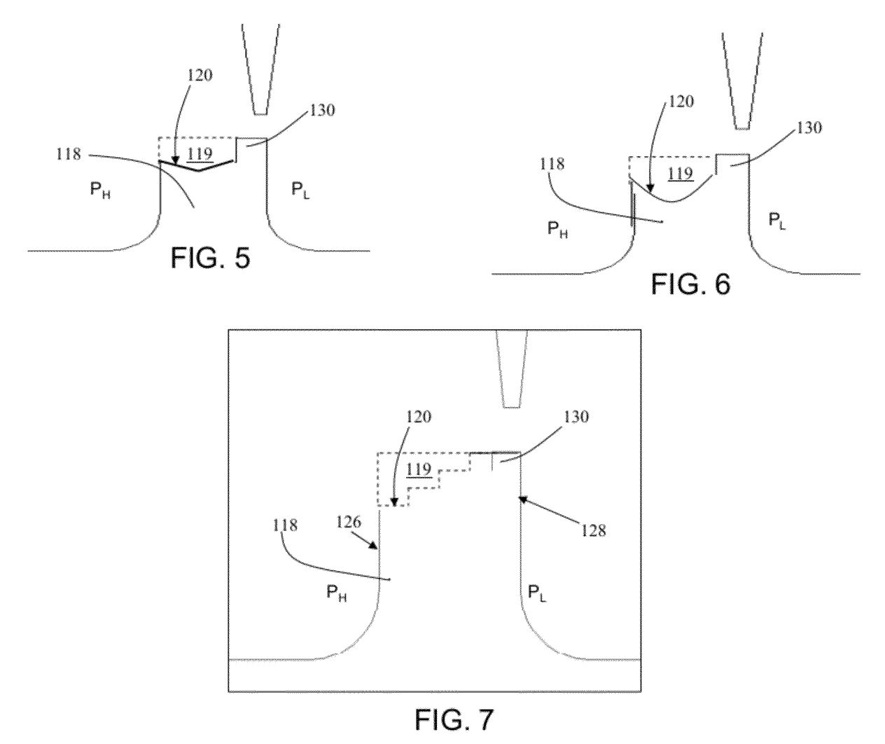

Examples of alternate geometries of groove 119, and protrusion 118 are shown in FIGS. 5-14. In one example, groove 119 could comprise a shape having at least one side that is shaped like the side of a square, a triangle, a trapezoid, a semi-circle, an oval, or any other geometrical shape desired. Groove 119 could also be any combination of geometric shapes, for example, partially curved, and partially planar. The shape of groove 119 that is machined out of high pressure side 126 can result in a shaped upper surface 120 of high pressure side 126, i.e., at least a portion of upper surface 120 can be planar, circular, semi-circular, or arced, or any combination thereof. For example, as shown in FIG. 5, groove 119 has one side that has a cross-section in the shape of an inverted triangle. As such, upper surface 120 has a corresponding v-shape. In another example, as shown in FIG. 6, groove 119 has at least one curved side, and therefore, upper surface 120 has a correspondingly curved shape. In another example, shown in FIG. 7, groove 119 can be stepped, i.e., comprising a series of steps, such that upper surface 120 would be stepped as well, stepping up from high pressure side 126 to low pressure side 128.

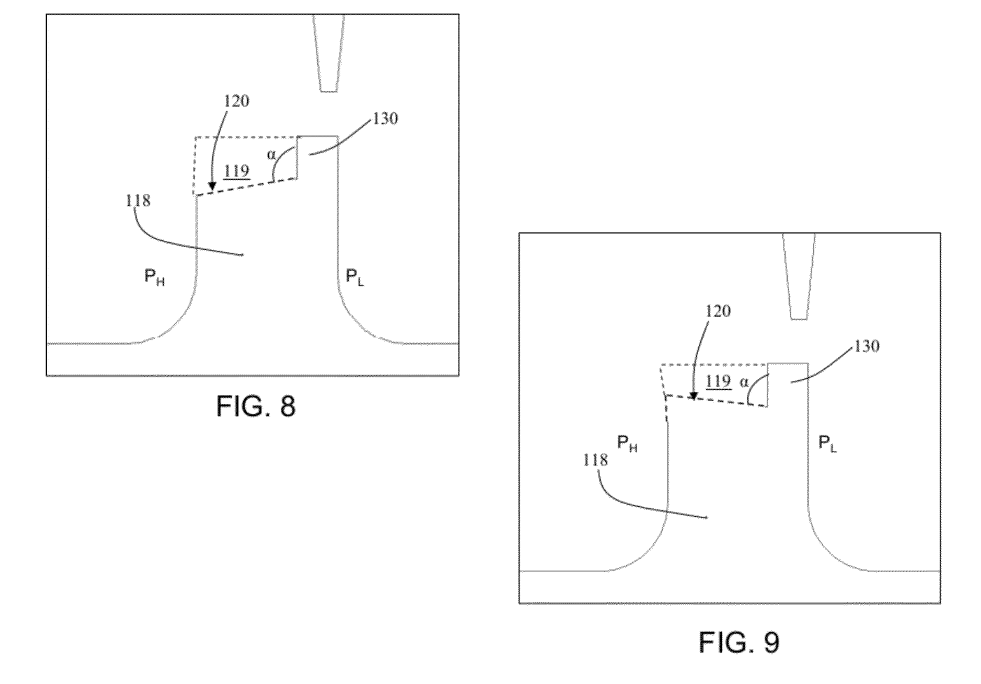

In other examples, as shown in FIGS. 8 and 9, groove 119 can be machined such that upper surface 120 is planar, but is also angled with respect to low pressure side 128. In these examples, an angle, α, between upper surface 120 and step 130 is not perpendicular, i.e., angle, α, is more than approximately 90 degrees (FIG. 8) or less than approximately 90 degrees (FIG. 9).

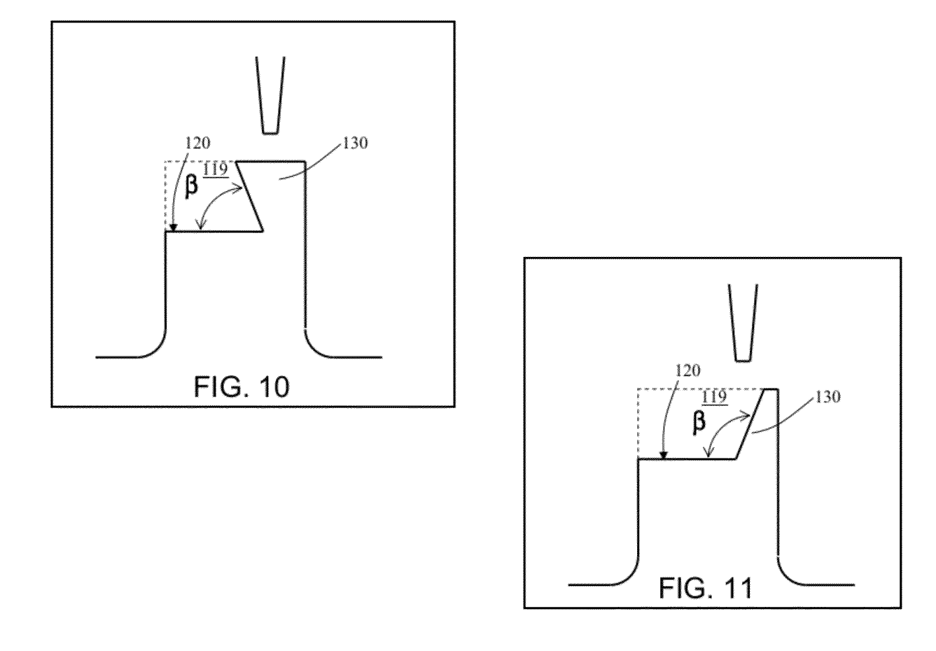

In other examples, as shown in FIGS. 10 and 11, groove 119 can be machined such that a high pressure side of step 130 is angled with respect to upper surface 120, such that an angle, β, can be either less than approximately 90 degrees (FIG. 10) or greater than approximately 90 degrees (FIG. 11).

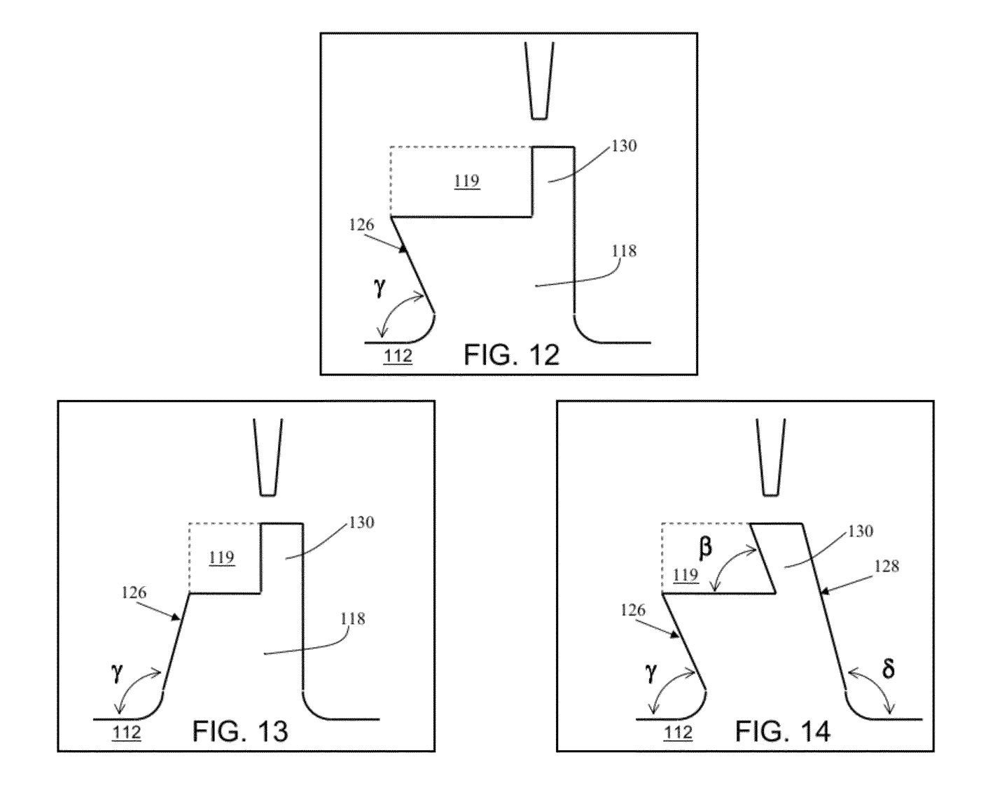

In other examples, as shown in FIGS. 12 and 13, high pressure side 126 of protrusion 118 is angled with respect to rotating component 112, such that angle, γ, can be either less than approximately 90 degrees (FIG. 12) or greater than approximately 90 degrees (FIG. 13). In another example, shown in FIG. 14, high pressure side 126 of protrusion 118 is angled with respect to rotating component 112 such that angle, γ, is less than approximately 90 degrees, high pressure side of step 130 is angled with respect to upper surface 120 such that an angle, β, is less than approximately 90 degrees, and low pressure side 128 of protrusion 118 is angled with respect to rotating component 112 such that angle, δ, is more than approximately 90 degrees.

It is understood that any size or shaped groove 119 can be machined in accordance with embodiments of this invention, which results in low pressure side 128 extending farther in a radial direction than high pressure side 126. For example, various aspects of the examples shown in FIGS. 5-14 can be combined as desired.

Returning to FIG. 4, a radial length of low pressure side 128 of protrusion 118, i.e., the extent to which low pressure side 128 extends in a radial direction, can also be modified as desired. For example, in one embodiment, low pressure side 128 can extend up to approximately 60% farther in the radial direction than high pressure side 126. In other words, a radial length, RL_{LP}, of low pressure side 128 can be up to approximately 60% longer than a radial length, RL_{HP}, of high pressure side 126. Height, h_{S}, of step 130 can also be expressed as a percentage of the total radial length, RL_{LP}, of low pressure side 128. For example, in one embodiment, height, h_{S}, can be up to approximately 60% of radial length, RL_{LP}. In one embodiment, shown in FIG. 4, a height, h_{S}, of step 130 is approximately 30 mils.

In addition, an axial length of step 130 can also be altered as desired. For example, an axial length, AL_{S}, in an axial direction of step 130 can comprise up to approximately 60% of a total axial length, AL_{P}, in an axial direction of protrusion 118. In one embodiment, shown in FIG. 4, total axial length, AL_{P}, of protrusion 118 is approximately 100 mils, while axial length, AL_{S}, of step 130 is approximately 20 mils, therefore, in this example, axial length, AL_{S}, of step 130 is approximately 20% of total axial length, AL_{P}, of protrusion 118. Axial length, AL_{S}, of step 130 can also be expressed in relation to an axial length, AL_{T}, of tip 122 of a tooth 116. In one embodiment, axial length AL_{S} of step 130 is up to approximately 60% larger than axial length AL_{T} of tip 122. For example, axial length AL_{S} can be approximately 10 mils to approximately 20 mils, while axial length AL_{T} can be approximately 5 mils to approximately 10 mils.

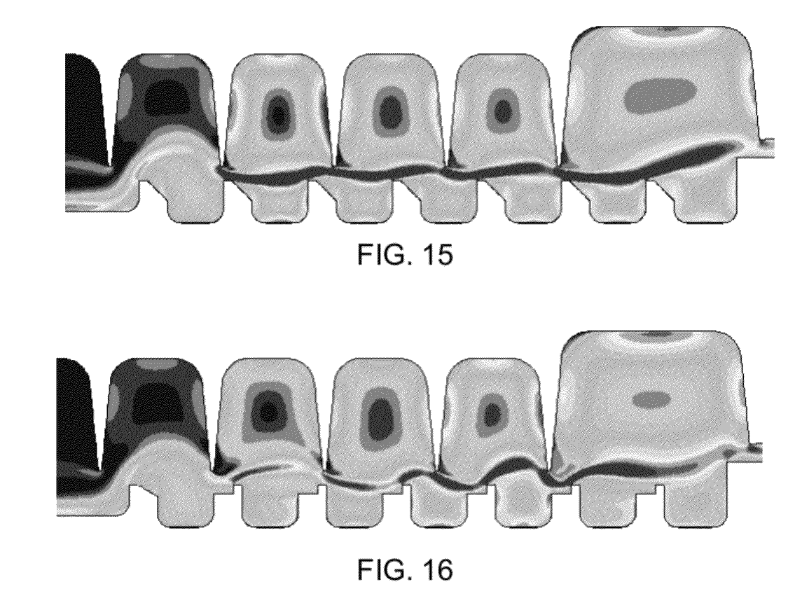

Generally, a capacity of a seal to reduce leakage is measured by a flow function, CQ. The lower CQ, the more effective the seal. Numerical testing has shown that labyrinth seal system 100 according to embodiments of this invention has a lower CQ than prior systems, regardless of whether teeth 116 and protrusions 118 are aligned. This is illustrated by comparing the infrared thermographic images in FIGS. 15 and 16, which indicate flow with the cooler (i.e., darker) lines near the bottom of the images. FIG. 15 illustrates a flow of operating fluid through labyrinth seal system 10, without all teeth/protrusions aligned, while FIG. 16 illustrates a flow of operating fluid through labyrinth seal system 100 according to an embodiment of this invention, also without all teeth/protrusions aligned. As observed by comparing the shape of the dark line in FIGS. 15 and 16, flow through labyrinth seal system 100 (FIG. 16) is more turbulent than flow through labyrinth seal system 10 (FIG. 15).

While seal system 100 results in a seal that will be effective, regardless of whether most, or all, of protrusions 118 and teeth 116 are axially aligned, seal system 100 can have increased effectiveness when at least some protrusions 118 and teeth 116 are axially aligned. For example, referring to a tooth 116 closest to high pressure side, P_{H}, of seal system 10 as a first tooth 116, and a tooth 116 proximate to the first tooth 116 as a second tooth 116, and referring to a protrusion 118 closest to high pressure side, P_{H}, of seal system 10 as a first protrusion 118, and a protrusion 118 proximate to the first protrusion 118 as a second protrusion 118, in one embodiment, at least second tooth 116 and second protrusion 118 are axially aligned. As shown in FIG. 3, first protrusion 118, proximate to high pressure side, P_{H}, can be any shape desired. In this embodiment, first protrusion 118 comprises a protrusion similar to protrusion 18 with a chamfer as in the prior art configuration shown in FIG. 2. However, a second protrusion 118, counting from high pressure side, P_{H}, and all subsequent protrusions 118, can be shaped according to the embodiments of this invention, i.e., with radially longer low pressure sides 128. When second protrusion 118 from high pressure side, P_{H} (i.e., protrusion 118 shaped with a radially longer low pressure side 128) is axially aligned with a tooth 116, flow will be sufficiently impeded through seal system 100, regardless of whether the remaining teeth 116 and protrusions 118 are axially aligned.

It is also understood that embodiments of this invention can be employed in any number of tooth/protrusion pairs in seal system 100. For example, any combination of existing shaped protrusions 18 (e.g., including chamfer 24 as shown in FIG. 2) and new shaped protrusions 118 (e.g., including a radially longer low pressure side 128, as shown in FIGS. 3-14) can be employed. For example, protrusions can alternate, with every other protrusion being a new shaped protrusion 118, or every third protrusion can be a new shaped protrusion, etc. It is also understood that the term “axially aligned” as used herein refers to a tooth/protrusion pair that are proximate to each other in an axial direction.

The terminology used herein is for the purpose of describing particular embodiments only and is not intended to be limiting of the disclosure. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” or “approximately” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A labyrinth seal system comprising:
a stationary component having a plurality of radially inwardly projecting, axially spaced teeth extending therefrom; and
a rotating component having an outer surface proximate to the plurality of teeth, wherein the outer surface includes a plurality of radially outwardly projecting, axially spaced protrusions, each protrusion having a low pressure side and a high pressure side, wherein the low pressure side of at least one protrusion extends farther in a radial direction than the high pressure side.

2. The labyrinth seal system of claim 1, wherein the low pressure side of the at least one protrusion is substantially rectangular.

3. The labyrinth seal system of claim 1, wherein at least one of:
an upper surface of the high pressure side is angled with respect to the low pressure side at an angle of more or less than approximately 90 degrees;
the high pressure side is angled with respect to the rotating component at an angle of more or less than approximately 90 degrees; and
the low pressure side is angled with respect to the rotating component at an angle of more or less than approximately 90 degrees.

4. The labyrinth seal system of claim 1, wherein a radial length of the low pressure side of the at least one protrusion is up to approximately 60% longer than a radial length of the high pressure side of the at least one protrusion.

5. The labyrinth seal system of claim 1, wherein a radial length of the low pressure side of the at least one protrusion is approximately 30 mils longer than a radial length of the high pressure side of the at least one protrusion.

6. The labyrinth seal system of claim 1, wherein an axial length of the low pressure side of the at least one protrusion comprises up to approximately 60% of an axial length of the at least one protrusion.

7. The labyrinth seal system of claim 1, wherein the plurality of teeth include a first tooth proximate to the high pressure side of the labyrinth seal, and a second tooth proximate to the first tooth, and the plurality of protrusions include a first protrusion proximate to the high pressure side of the labyrinth seal and a second protrusion proximate to the first protrusion, and wherein the at least one protrusion is the second protrusion, and wherein the second protrusion and the second tooth are substantially axially aligned.

8. The labyrinth seal system of claim 1, wherein at least every other protrusion in the plurality of protrusions has a low pressure side that extends farther in a radial direction than a high pressure side.

9. The labyrinth seal system of claim 1, wherein the high pressure side has an upper surface having at least a portion that has a shape that is selected from the following: planar, circular, semi-circular, stepped and arced.

10. The labyrinth seal system of claim 1, wherein at least one tooth has a tip proximate to the at least one protrusion, and wherein an axial length of the low pressure side of the at least one protrusion is up to approximately 60% longer than an axial length of the tip of the at least one tooth.

11. A turbomachine comprising:
a plurality of arcuate packing ring segments disposed in an annular groove in a stationary component; each arcuate packing ring segment having a seal face having a plurality of radially inwardly projecting, axially spaced teeth extending therefrom; and
a rotating component having an outer surface proximate to the plurality of teeth, wherein the outer surface includes a plurality of radially outwardly projecting, axially spaced protrusions, each protrusion having a low pressure side and a high pressure side, wherein the low pressure side of at least one protrusion extends farther in a radial direction than the high pressure side of the at least one protrusion.

12. The turbomachine of claim 11, wherein the low pressure side of the at least one protrusion is substantially rectangular.

13. The turbomachine of claim 11, wherein at least one of:
an upper surface of the high pressure side is angled with respect to the low pressure side at an angle of more or less than approximately 90 degrees;
the high pressure side is angled with respect to the rotating component at an angle of more or less than approximately 90 degrees; and
the low pressure side is angled with respect to the rotating component at an angle of more or less than approximately 90 degrees.

14. The turbomachine of claim 11, wherein a radial length of the low pressure side of the at least one protrusion is up to approximately 60% longer than a radial length of the high pressure side of the at least one protrusion.

15. The turbomachine of claim 11, wherein a radial length of the low pressure side of the at least one protrusion is approximately 30 mils longer than a radial length of the high pressure side of the at least one protrusion.

16. The turbomachine of claim 11, wherein an axial length of the low pressure side of the at least one protrusion comprises up to approximately 60% of an axial length of the at least one protrusion.

17. The turbomachine of claim 11, wherein the plurality of teeth include a first tooth proximate to a high pressure side of the turbomachine, and a second tooth proximate to the first tooth, and the plurality of protrusions include a first protrusion proximate to a high pressure side of the turbomachine and a second protrusion proximate to the first protrusion, and wherein the at least one protrusion is the second protrusion, wherein the second protrusion and the second tooth are substantially axially aligned.

18. The turbomachine of claim 11, wherein the high pressure side has an upper surface having at least a portion that has a shape that is selected from the following: planar, circular, semi-circular, stepped and arced.

19. The turbomachine of claim 11, wherein at least one tooth has a tip proximate to the at least one protrusion, and wherein an axial length of the low pressure side of the at least one protrusion is up to approximately 60% longer than an axial length of the tip of the at least one tooth.

20. The turbomachine of claim 11, wherein at least every other protrusion in the plurality of protrusions has a low pressure side that extends farther in a radial direction than a high pressure side.
